(19) United States
(12) Patent Application Publication
(10) Pub. No.: US 2020/0122774 A1
(43) Pub. Date: Apr. 23, 2020

(54) THREE-WHEELED VEHICLE

(71) Applicants: Georgiy Volodymyrovych Beylin, Kiev (UA); Sergiy Yuriiovich Petrenko, Kiev (UA)

(72) Inventors: Georgiy Volodymyrovych Beylin, Kiev (UA); Sergiy Yuriiovich Petrenko, Kiev (UA)

(21) Appl. No.: 16/626,936

(22) PCT Filed: Aug. 4, 2017
(86) PCT No.: PCT/UA2017/000080

§ 371 Date: Dec. 27, 2019

(51) Int. Cl. B62D 9/02; B62D 61/08

(52) U.S. Cl. CPC B62D 9/02; B60G 2800/24; B62D 61/08

(57) ABSTRACT

A three-wheeled vehicle having a frame with articulated four-link straight line linkage mechanism mounted thereon, said mechanism including lateral arms arranged symmetrically about the axis of symmetry of the vehicle, and also one conditionally front wheel, and two conditionally rear wheels, each having an axis. The articulated four-link straight line linkage mechanism also includes a linear steering mechanism, a T-shaped arm, a short central arm, an O-shaped bracket, a rubber-strand torsion member of the conditionally front wheel, and one rubber-strand torsion member and L-shaped wheel arm per each conditionally rear wheel, which form a rear axle connected to the linear steering mechanism via the T-shaped linkage arm. The result is increased stability when cornering at a speed, and more accurate steering.

### BACKGROUND OF THE INVENTION

### 1. Field of the Invention

The present invention pertains to terrestrial three-wheeled vehicles. It can be used to construct three-wheeled vehicles possessing increased stability when cornering at relatively high speeds.

### 2. Description of Related Art

In terms of the number of essential features, the closest analogue of the proposed invention is a three-wheeled vehicle (TWV) comprising a frame with articulated four-link straight line linkage mechanism mounted thereon, said mechanism comprising lateral arms arranged symmetrically about the axis of symmetry of the vehicle, and also one conditionally front wheel, and two conditionally rear wheels, each having an axis [U.S. Pat. No. 3,539,196, IPC3 B62D 7/06, U.S. Cl. 280/92; 280/62, Patented Nov. 10, 1970]. The described TWV is equipped with an arm steering mechanism with steering arms kinematically coupled with the lateral arms and conditionally front wheel. The suspension of the steered (front) wheel in the described device is built on the basis of the Roberts articulated four-link straight line linkage mechanism.

During cornering, the position of the described TWV is stabilized by lateral movement of the steerable wheel as it turns. When cornering, the steerable wheel moves from the vehicle's axis of symmetry to the side opposite to the direction of turning of the vehicle in order to counteract the centrifugal force acting to overturn the vehicle during cornering. Simultaneous cornering and lateral shift of the steerable wheel is achieved by installing the steerable wheel on an axis pivotally connected with the ends of a pair of spaced apart arms. Said pair of arms is capable of cornering only in the horizontal plane in hinges located at some distance from each other on the vehicle frame. The disadvantages of the mentioned vehicle include the fact that the cornering of the steerable (front) wheel is effected by a mechanism with shortened arms, which significantly reduces the accuracy of steering. In addition, the specified TWV does not allow automatic tilting of the body towards the side of turning, it does not have a device for damping the steerable wheel, in case of repair the access to the steerable wheel is difficult due to its placement on the axis with hinges.

### SUMMARY OF THE INVENTION

Therefore, the present invention is aimed to provide such a TWV, which would be more stable during cornering at a speed and would enable more accurate steering. The objective is achieved by creating conditions for controlling the spatial position of the TWV by using a linear steering mechanism connected through a T-shaped linkage arm to a conditionally rear axle. Meanwhile, the larger the turning angle of the conditionally front steerable wheel, the bigger is the inclination angle of the frame.

The proposed design is also aimed to create conditions for easy replacement of a wheel in case of repair and the possibility of towing the vehicle on a rigid towline.

Similar to the TWV of the prior art, the proposed TWV comprises a frame with articulated four-link straight line linkage mechanism mounted thereon, said mechanism comprising lateral arms arranged symmetrically about the axis of symmetry of the vehicle, and also one conditionally front wheel, and two conditionally rear wheels, each having an axis, while according to the invention, the articulated four-link straight line linkage mechanism also comprises a linear steering mechanism, a T-shaped arm, a short central arm, an O-shaped bracket, a rubber-strand torsion member of the conditionally front wheel, and one rubber-strand torsion member and L-shaped wheel arm per each of conditionally rear wheels, which form a rear axle connected to the linear steering mechanism via the T-shaped linkage arm, and each rubber-strand torsion member is made in the form of a tubular housing with a movable insert located in the housing, two conditionally rear wheels form an axle comprising two identical rubber-strand torsion members—one torsion member per each of conditionally rear wheels mounted on the corresponding L-shaped wheel arm pivotally attached to the frame, the axle torsion member housings are kinematically connected to the corresponding ends of the T-arm, the rubber-strand torsion member housing of the conventional front wheel is rigidly attached to the frame and is located perpendicular to the symmetry axis of the vehicle, hinges are attached to the ends of the movable rubber-torsion member insert, said hinges being mounted on the corresponding ends of the lateral arms in such a manner to enable their synchronous rotation in horizontal and vertical planes, short arm is divided into two parts, each of said parts is being fixed on the corresponding side of the O-shaped bracket having, on its side surface, a slot enabling free rotation of the conventionally front steerable wheel with the possibility of placing its axis in a position lower than the short arm axis, and the O-shaped bracket is provided with a hitch bracket on one its side and with a steering arm on its another side.

A feature of the proposed TWV is that the rubber-strand torsion members of the axle and the L-shaped wheel arms oriented in one direction form an articulated axle.

Another feature of the proposed TWV is that the rubber-strand torsion members of the axle and the L-shaped wheel arms oriented in different directions form a solid axle.

Yet another feature of the proposed TWV is that the O-shaped bracket, the hitch bracket and the steering arm are all-in-one-piece.

The steerable wheel suspension of the proposed TWV is based on the Roberts articulated four-link straight line linkage mechanism [see Nos. 622-626 at the website http://azbukametalla.ru/mekhanizmy/chast-l/sharnirno-rychazhnye-mekhanizmy/608-703-mekhanizmy-napravlyayushchie-i-inversory.html]. In the proposed TWV structure, the lateral arms of the mechanism have two degrees of freedom, can synchronously rotate in the horizontal plane due to the hinges, and in the vertical plane due to the rubber-strand torsion member, i.e. a long arm of the four-link mechanism mounted on the vehicle body. The hinges of the arms are mounted at the ends of the metal movable insert of the torsion member, and the torsion member housing is rigidly fixed to the frame. For the optimal fastening of the steerable wheel, the short arm is divided into two parts, each being fixed on the corresponding side of the O-shaped bracket. A slot is made on the side surface of the O-shaped bracket for mounting the steerable wheel in such a manner that the rotation axis of the wheel is located closer to the frame and lower than the axis of the short arm. The O-shaped bracket has a hitch bracket on one its side (the side farthest from the vehicle body) and a steering arm on the other side (the side closest to the vehicle body). All three parts are made as all-in-one-piece. Such short arm structure with a hitch device and a steering arm and an offset arrangement of the steerable wheel axis increases stability during cornering due to an increase in lateral offset of the wheel contact point (area) off the vehicle axis. This technical solution provides both easy wheel replacement in case of repair and the possibility of towing on a rigid hitch and makes it possible to use a linear steering mechanism.

The proposed TWV structure enables automatic proportional tilting of the vehicle body in the direction of cornering, when turning the steering wheel. For this purpose, an articulated axle with rubber-strand torsion members and L-shaped wheel arms oriented in one direction, or a solid axle with torsion members and L-shaped wheel arms oriented in different directions. The spatial position of the axle is controlled by the linear steering mechanism via the T-shaped linkage arm in case of an articulated axle and via the L-shaped linkage arm in case of a solid axle.

The use of a solid axle with rubber-strand torsion members and L-shaped wheel arms oriented in different directions increases comfort when overcoming obstacles on the road located perpendicular to the direction of vehicle movement.

At the time of patent information research performed in the process of the present application preparation the authors have not revealed any TWVs possessing the above-mentioned set of essential features, which proves that the claimed technical solution complies with “novelty” patentability criterion.

The technical result attained as a result of the implementation of the present invention is in providing conditions for controlling the spatial position of the TWV by using a linear steering mechanism connected through a T-shaped linkage arm to a conditionally rear axle, which is aimed at increasing the TWV stability when cornering at relatively high speeds.

The authors have not revealed the indicated technical result in the known technical solutions of the prior art, therefore the proposed TWV may be deemed to comply with the “inventive step” patentability criterion.

The proposed TWV consists of structural elements, which may be manufactured using presently known technological methods, means and materials. It may be used in vehicles in different sectors of economy, i.e. in traditional vehicles, electric vehicles and special vehicles, such as baby carriages, wheelchairs, mobile robotic systems; therefore, it is possible to conclude that the proposed solution complies with “industrial applicability” patentability criterion.

### BRIEF DESCRIPTION OF THE DRAWINGS

The essence of the proposed invention is further explained using schematic drawings, where:

FIG. 1 is a kinematic diagram of a TWV with an articulated axle.

FIGS. 2, 3 show a general view of the TWV with an articulated axle.

FIGS. 4, 5 show the TWV view with a turned wheel and an articulated axle.

FIGS. 6, 7 show a general view of the TWV with a solid axle.

FIGS. 8, 9 show the TWV view with a turned wheel and a solid axle.

FIG. 10 illustrates a vehicle body tilt during a cornering.

FIG. 11 shows a towed trailer.

### DESCRIPTION OF THE EMBODIMENT(S)

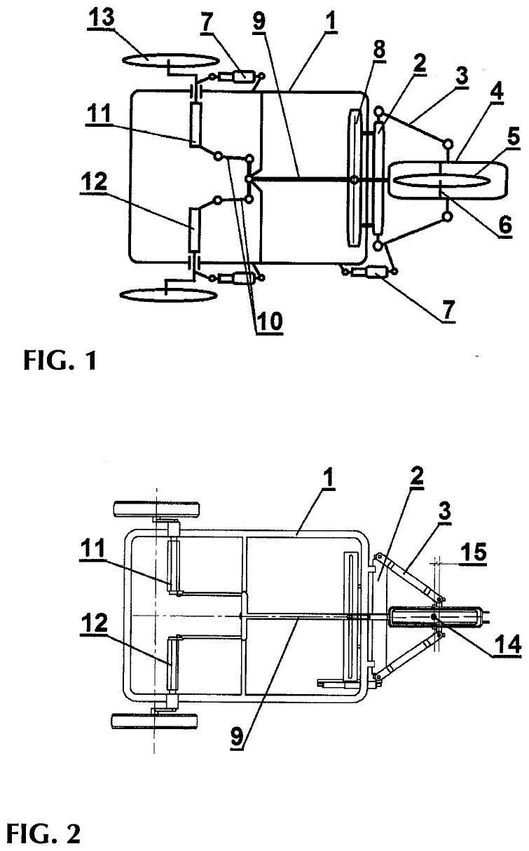

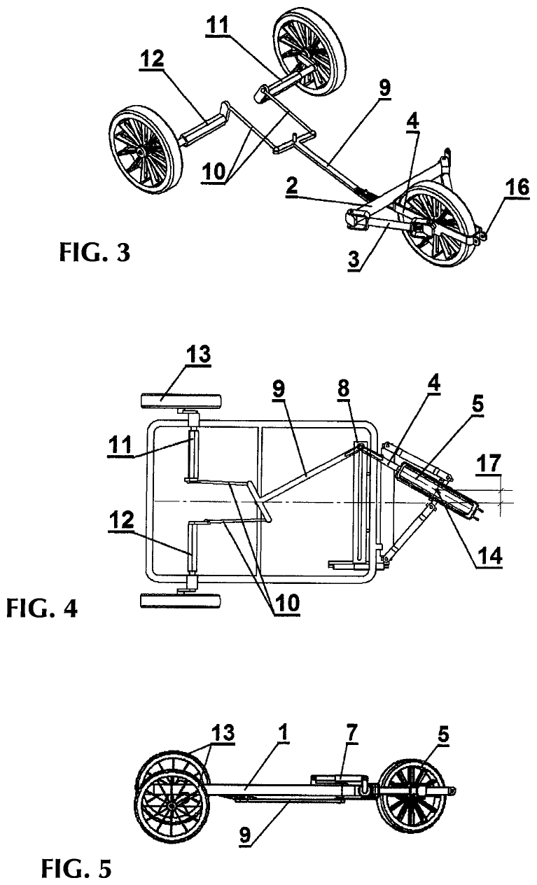

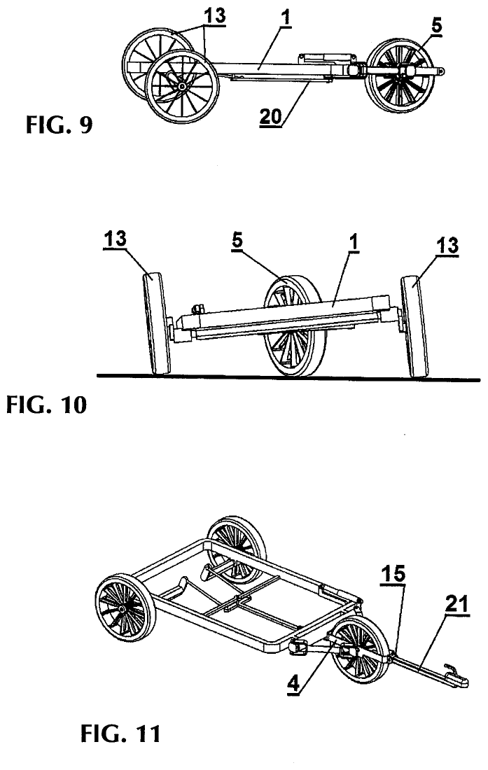

In describing the embodiment of the present invention, reference will be made herein to FIGS. 1-11 of the drawings in which like numerals refer to like features of the invention.

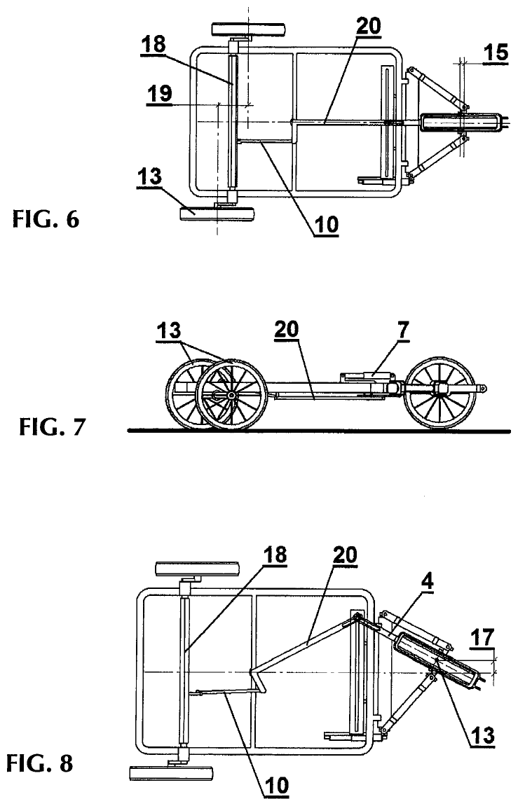

The proposed three-wheeled vehicle consists of a suspension and a body (not shown). The suspension (FIGS. 1, 2, 3, 6) consists of a frame 1 with a rubber-strand torsion member 2 fixed thereon, two lateral arms 3, a short arm 4, a conditionally front steerable wheel 5 with an axis 6, shock absorbers 7, a linear steering mechanism 8, T-shaped arm 9, rods 10, an articulated axle formed by rubber-strand torsion members with L-shaped wheel arms 11 and 12 (shown in the assembly), two conditionally rear wheels 13. A wheel 5 with an axis 6 is mounted on a short arm 4 in such a manner that the roadway surface contact point 14 of the wheel 5 has an offset 15 (see FIG. 2) relative to the axis of the short arm 4. The short arm 4 has a hitch bracket 16. Suring wheel 5 turning, the contact point 14 gains the offset 17 relative to the axis of symmetry of the vehicle. The use of the solid axle 18 with torsion members and L-shaped wheel arms oriented in different directions (see FIG. 6) simplifies the structure. The location of the wheel 13 with an offset 19 relative to the axis of the torsion member makes it possible to use the L-shaped arm 20 with one rod 10 instead of the T-shaped arm 9 and two rods 10. Tow bar 21 attachment to the hitch bracket 16 allows to tow the TWV on a rigid hitch.

The proposed TWV operates as follows: moving a controlling component of the linear steering mechanism 8 causes a change in the position of the short arm 4 and, consequently, the synchronous change of positions of the two lateral arms 3. Meanwhile, the conditionally front steerable wheel 5 mounted on the axis 6 occupies the position in which the contact point 14 gains the offset 17 relative to the axial line of the frame 1 (see FIGS. 4, 8) Such offset of the contact point 14 of the wheel 5 from the axis of symmetry of the vehicle to the side opposite to the side of the turn improves stability during cornering, also at a relatively high speed. Along with the change of the short arm 4 position (FIG. 4), the positions of the T-shaped arm 9, rods 10, an articulated axle formed by rubber-strand torsion members with L-shaped wheel arms 11 and 12 (shown in the assembly), two wheels 13 change as well. Here, due to the reciprocal synchronous movement of the wheels 13, a lateral tilt of the vehicle body occurs (FIGS. 5, 10) The use of a solid axle 18 with rubber-strand torsion members and L-shaped wheel arms oriented in different directions (see FIGS. 8, 9, 10) allows to use the L-shaped arm 20 and one rod 10. Attached to the hitch bracket 16, the tow bar 21 allows to tow the TWV on a rigid hitch in order to use the TWV as a trailer.

Offset 19 (see FIG. 6) provides more comfort in overcoming obstacles located perpendicular to the direction of the vehicle movement. Rubber-strand torsion members 2, 11, 12, 18 provide smooth running for all possible TWV embodiments.

Using the described structure of the short arm 4 with the hitch device and the steering arm, as well as the linear steering mechanism 8 provides higher accuracy in controlling the angular position of the steerable wheel 5. This allows to create a TWV with front or rear steering wheel and also with various drive arrangements: one wheel (i.e. steerable wheel) drive; two wheels drive; three wheels drive using either electric motor wheels or a traditional drive from an internal combustion engine.

Based on the proposed TWV the following structures can be created:

Two to four seats city electric car, One or two seats commercial vehicle for loads transportation, Towed trailer, etc.

### LIST OF ITEMS IN THE DRAWINGS

1—frame
2—rubber-strand torsion member
3—lateral arms
4—short arm
5—conditionally front steerable wheel
6—wheel 5 axis
7—shock absorber
8—linear steering mechanism
9—L-shaped arm
10—rod
11, 12—L-shaped wheel arms
13—conditionally rear wheels
14—point of the wheel 5 contact with the surface of the roadway
15—offset relative to the axis of the short arm 4
16—hitch bracket
17—contact point 14 offset relative to the axial line of the frame 1
18—solid axle with torsion members and L-shaped wheel arms oriented in different directions
19—wheels 13 offset relative to the torsion member axis
20—L-shaped arm
21—tow bar

While the present invention has been particularly described, in conjunction with one or more specific embodiments, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. A three-wheeled vehicle comprising a frame with articulated four-link straight line linkage mechanism mounted thereon, said mechanism comprising lateral arms arranged symmetrically about the axis of symmetry of the vehicle, and also one conditionally front wheel, and two conditionally rear wheels, each having an axis, wherein the articulated four-link straight line linkage mechanism also comprises a linear steering mechanism, a T-shaped arm, a short central arm, an O-shaped bracket, a rubber-strand torsion member of the conditionally front wheel, and one rubber-strand torsion member and L-shaped wheel arm per each of conditionally rear wheels, which form a rear axle connected to the linear steering mechanism via the T-shaped linkage arm, and each rubber-strand torsion member is made in the form of a tubular housing with a movable insert located in the housing, two conditionally rear wheels form an axle comprising two identical rubber-strand torsion members—one torsion member per each of conditionally rear wheels mounted on the corresponding L-shaped wheel arm pivotally attached to the frame, the axle torsion member housings are kinematically connected to the corresponding ends of the T-arm, the rubber-strand torsion member housing of the conventional front wheel is rigidly attached to the frame and is located perpendicular to the symmetry axis of the vehicle, hinges are attached to the ends of the movable rubber-torsion member insert, said hinges being mounted on the corresponding ends of the lateral arms in such a manner to enable their synchronous rotation in horizontal and vertical planes, short arm is divided into two parts, each of said parts is being fixed on the corresponding side of the O-shaped bracket having, on its side surface, a slot enabling free rotation of the conventionally front steerable wheel with the possibility of placing its axis in a position lower than the short arm axis, and the O-shaped bracket is provided with a hitch bracket on one its side and with a steering arm on its another side.

2. The three-wheeled vehicle according to claim 1, characterized in that the rubber-strand torsion members of the axle and the L-shaped wheel arms oriented in one direction form an articulated axle.

3. The three-wheeled vehicle according to claim 1, characterized in that the rubber-strand torsion members of the axle and the L-shaped wheel arms oriented in different directions form a solid axle.

4. The three-wheeled vehicle according to claim 1, characterized in that the O-shaped bracket, the hitch bracket and the steering arm are all-in-one-piece.
